(19) United States
(12) Patent Application Publication
(10) Pub. No.: US 2015/0213752 A1
(43) Pub. Date: Jul. 30, 2015

(54) ADJUSTABLE SCREEN DISPLAY SIZE FOR AN ELECTRONIC DEVICE

(71) Applicant: Nvidia Corporation, Santa Clara, CA (US)

(72) Inventors: Xianpeng Huang, Suzhou (CN); Qiang Chen, Shenzhen (CN); Tan Zhi, Shenzhen (CN)

(73) Assignee: Nvidia Corporation, Santa Clara, CA (US)

(21) Appl. No.: 14/166,639

(22) Filed: Jan. 28, 2014

(51) Int. Cl. G09G 3/20

(52) U.S. Cl. CPC G09G 3/2092; G09G 2330/023

(57) ABSTRACT

One aspect provides a method for image display. The method for image display, in accordance with one embodiment, includes providing a display, the display having a maximum display area (Aₘₐₓ) defined by a total number of pixels. The method for image display, in accordance with this embodiment, may further include activating, in an attempt to extend battery life, less than all of the total number of pixels of the display to provide a modified display area (A_{mod}) that is less than the maximum display area (Aₘₐₓ).

### TECHNICAL FIELD

This application is directed, in general, to a display and, and more specifically, to an adjustable screen display size for an electronic device.

### BACKGROUND

Electronic devices, particularly communication devices such as smartphones, tablets, ultra slim notebooks, and MP3 players, as well as other battery-operated devices, have made vast strides in performance over the last decade or so. Generally, the trend is to embody larger and higher resolution LCD/LED displays to get a better user experience. Unfortunately, embodying larger and higher resolution LCD/LED displays tends to degrade battery performance.

Accordingly, what is needed in the art is an electronic device, or device for use therewith, that navigates the foregoing battery performance problems.

### SUMMARY

One aspect provides a method for image display. The method for image display, in accordance with one embodiment, includes providing a display, the display having a maximum display area (Aₘₐₓ) defined by a total number of pixels. The method for image display, in accordance with this embodiment, may further include activating less than all of the total number of pixels of the display to provide a modified display area (A_{mod}) that is less than the maximum display area (Aₘₐₓ) to reduce power consumption of the display.

Further provided is an electronic device. In accordance with one embodiment of the disclosure, the electronic device may include a display having a maximum display area (Aₘₐₓ) defined by a total number of pixels. The electronic device, in this embodiment, may further include storage and processing circuitry associated with the display, the storage and processing circuitry operable to activate less than all of the total number of pixels of the display to provide a modified display area (A_{mod}) that is less than the maximum display area (Aₘₐₓ) to reduce power consumption of the display.

### BRIEF DESCRIPTION

Reference is now made to the following descriptions taken in conjunction with the accompanying drawings, in which:

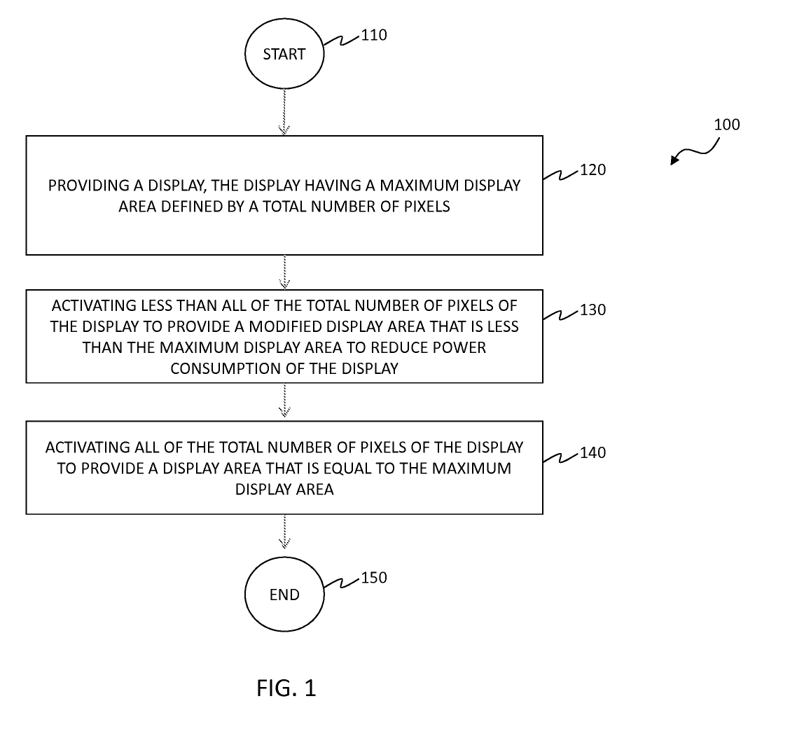

FIG. 1 illustrates a flow diagram of one embodiment of a method for image display;

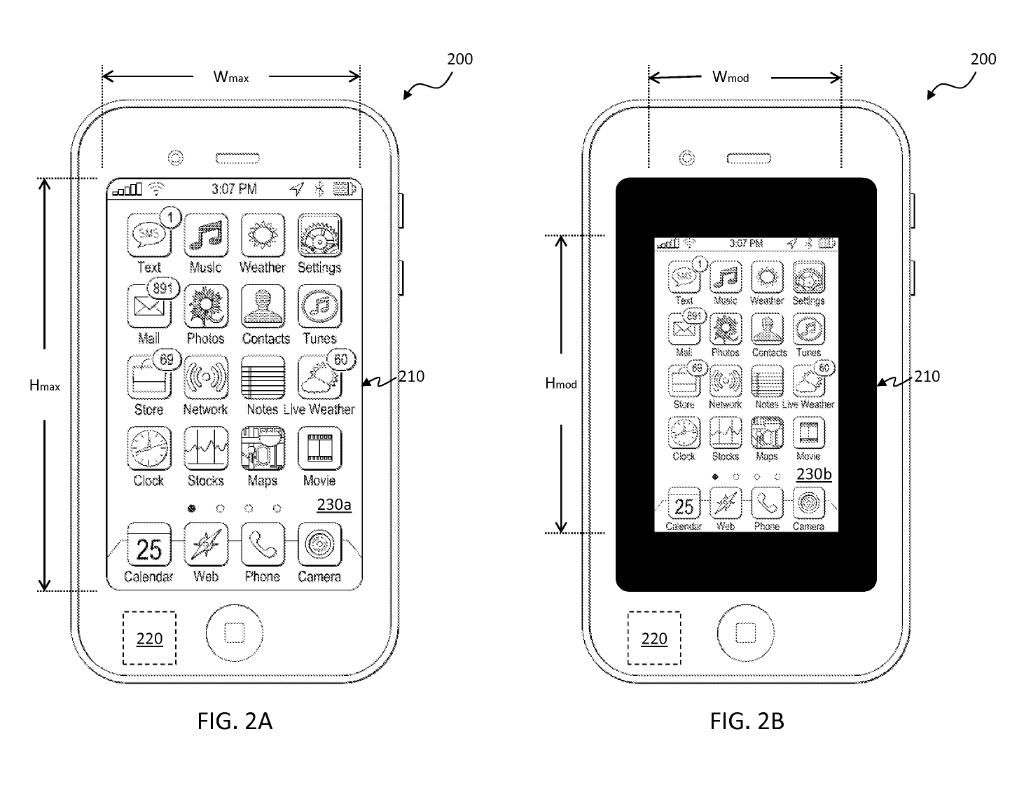

FIGS. 2A and 2B illustrate aspects of a representative embodiment of an electronic device in accordance with embodiments of the disclosure;

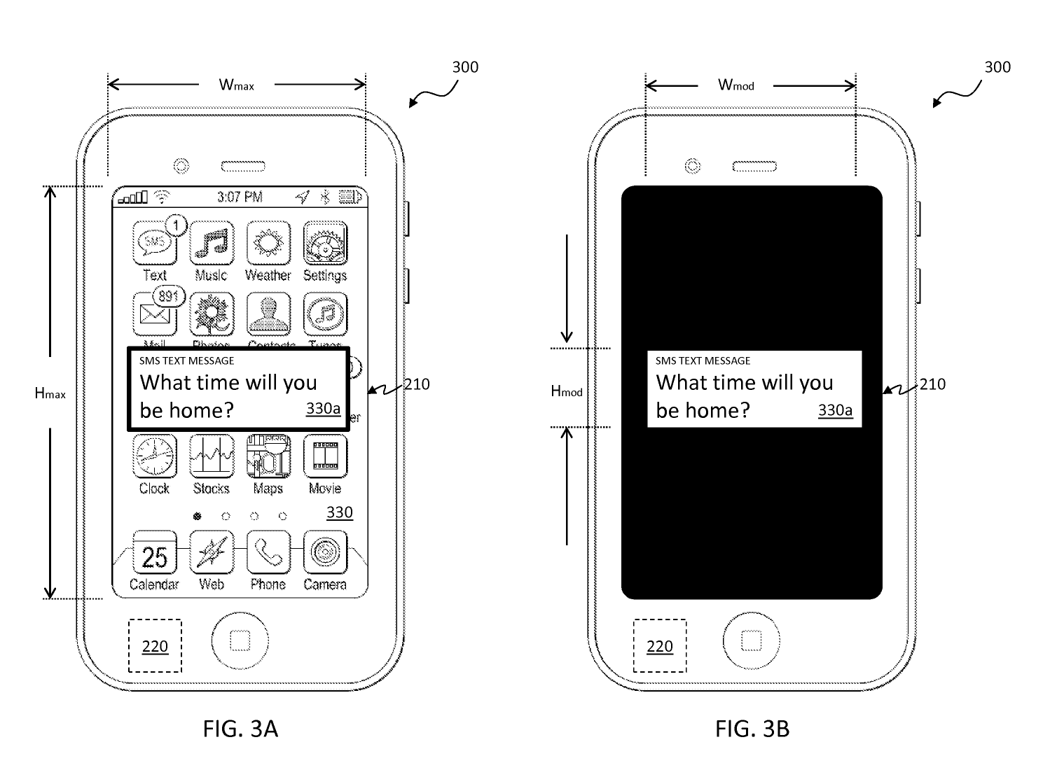

FIGS. 3A and 3B illustrate aspects of an alternative embodiment of an electronic device in accordance with embodiments of the disclosure; and

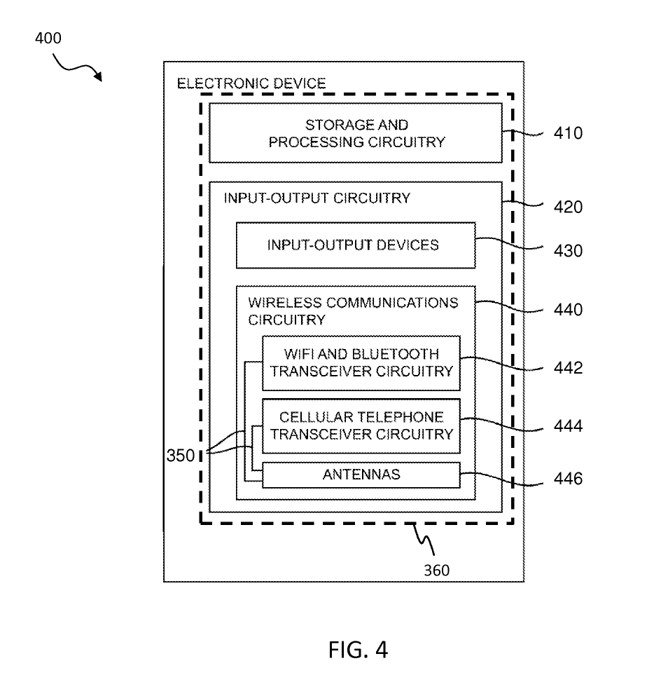

FIG. 4 illustrates a schematic diagram of electronic device, as might be used with a display manufactured and operated in accordance with this disclosure.

### DETAILED DESCRIPTION

The present disclosure is based, at least in part, on the acknowledgement that users of today's electronic devices often tend to demand extended battery life. In an attempt to conserve power, users of such devices tend to physically turn off the display. Users of such devices also tend to decrease the display brightness in an attempt to conserve power. Unfortunately, such precautionary actions are often insufficient.

With the foregoing acknowledgement in mind, the present disclosure has recognized that a significant amount of power may be conserved by electronically reducing the display area of the screen. For example, the present disclosure has recognized that for a display having a maximum display area (Aₘₐₓ) defined by a total number of pixels, less than all of the total number of pixels may be activated to provide a modified display area (A_{mod}) that is less than the maximum display area (Aₘₐₓ). By activating less than all of the total number of pixels (e.g., also referred to herein as the pixel activation reduction feature), power consumption of the display may be reduced, and thus battery life extended.

The term activating, as used throughout this disclosure, means powering. Thus, if a pixel is activated, power is sent to the pixel. Alternatively, if a pixel is not activated, or un-activated, no power is being sent to the pixel.

The above-discussed acknowledgments, and benefits that result therefrom, will briefly be discussed with reference to an Apple IPhone 5 having approximately a 3.5 inch by 2 inch display, defining a maximum display area (Aₘₐₓ) of approximately square inches. In accordance with one embodiment of the disclosure, the Apple IPhone 5 screen size could be electronically reduced to approximately 1.75 inches by 1 inch, defining a modified display area (A_{mod}) of approximately 1.75 square inches. In this example, the pixels in the modified display area (A_{mod}) would be activated, while those outside the modified display area (A_{mod}) would not be activated. Further to this example, the modified display area (A_{mod}) would be at least about 75% less than the maximum display area (Aₘₐₓ) of the Apple IPhone 5. Accordingly, a related amount of energy (e.g., possibly up to 75% of the energy required to operate the display) could potentially be conserved.

The preceding IPhone 5 example assumes that the modified display area (A_{mod}) would be about 75% less than the maximum display area (Aₘₐₓ). Notwithstanding, much less significant reductions in effective screen size still provide substantial energy savings. For example, substantial energy savings may be achieved by simply requiring that the modified display area (A_{mod}) be at least about 66%, or even 50% less, than the maximum display area (Aₘₐₓ). Similarly, useful energy savings may be achieved by requiring that the modified display area (A_{mod}) be at least about 33%, or even at least about 20%, less than the maximum display area (Aₘₐₓ). The present disclosure has recognized that so long as the modified display area (A_{mod}) is at least about 5% less than the maximum display area (Aₘₐₓ), useful energy saving may be achieved. Notwithstanding the foregoing, any intentional reduction in screen size, even if less than a 5% reduction, is within the purview of the present disclosure.

The modified screen area (A_{mod}) may be achieved a number of different ways. In most scenarios, the modified screen area (A_{mod}) would be achieved by electronically reducing the size of the display. This electronic reduction in size of the display would tend to have a bar of un-activated pixels along one or more sides of the display. In many embodiments, an aspect ratio (width:height) of the image on the display and an image on the electronically reduced display would be substantially equal. In one embodiment bars of un-activated pixels exist along all four sides of the display. Other embodiments exist, however, wherein bars of un-activated pixels exist along only three, or only two, sides of the display. Alternatively, the aspect ratio of the image on the display and the image on the electronically reduced display would differ, sometimes being radically different.

In yet another embodiment in accordance with the disclosure, the outer display dimensions could remain the same, but individual pixels within the outer display dimensions would be un-activated. For example, the pixels of the display could be separated into groups, wherein one or more pixels within each group are un-activated. For example, if each of the groups consists of a 3×3 matrix of pixels, a centermost pixel of each of the 3×3 matrix of pixels might be un-activated, resulting in approximately an 11% reduction in display area. If each of the groups consisted of a 4×4 matrix of pixels, the centermost four pixels of each of the 4×4 matrix of pixels might be un-activated, resulting in approximately a 25% reduction in display area. Such an embodiment effectively reduces a resolution of the display, thereby conserving energy by activating less than all of the total number of pixels. Those skilled in the art further understand that certain embodiments may exist wherein multiple different pixel activation reduction features types are used in conjunction with one another.

The process for activating less than all of the total number of pixels may be user definable. For example, the user of the device may define certain criteria whereby less than all of the total number of pixels is activated. In certain instances, the user may program the display, or at least software that is controlling the display, such that the pixel activation reduction feature is employed only when an amount of remaining battery life dips below a specified amount. For example, the user might program the display such that the pixel activation reduction feature is employed when the remaining battery life dips below 50%, below 30%, below 20%, or even below a critical battery life of 10% or less.

In an alternative embodiment, the user may program the display such that the pixel activation reduction feature is employed, or not employed, based upon the type of image being displayed. For example, when certain types of images are being displayed the pixel activation reduction feature would be employed, and when other types of images are being displayed the pixel activation reduction feature would not be employed. As one example, the pixel activation reduction feature might engage for electronic book images, caller information images, text message images, and/or email message images, among others. On the other hand, the pixel activation reduction feature might not engage when viewing videos, using the Internet on the device, typing on the screen, etc. In this same light, the pixel activation reduction feature might engage and/or disengage based upon habits of the user.

The above discussion focuses on the ability of the user to precisely define one or more parameters for the pixel activation reduction feature. Other embodiments may exist wherein the user is limited to a select few options for programming the pixel activation reduction feature. Yet other embodiments may exist wherein the pixel activation reduction features may only be turned on and/or turned off by the user. Even yet other embodiments exist wherein the pixel activation reduction features are pre-programmed and may not be modified in any way by the user.

FIG. 1 is a flow diagram 100 of one embodiment of a method for image display. The method for image display begins in a start step 110. The message for image display continues on to step 120 wherein a display having a maximum area (Aₘₐₓ) defined by a total number of pixels is provided. The display, in accordance with one embodiment of the disclosure, might be an LCD display. In accordance with another embodiment of the disclosure, the display might be an LED display. Nevertheless, other displays wherein each of the pixels may be individually activated, whether currently known or hereafter discovered, are within the purview of the disclosure.

In a step 130, less than all of the total number of pixels of the display are activated to provide a modified display area (A_{mod}) that is less than the maximum display area (Aₘₐₓ). In accordance with the disclosure, this is configured to reduce power consumption of the display, and thus extend battery life as a result. The step 130 of activating less than all of the total number of pixels of the display is an active (e.g., intentional) step, as opposed to unintentional. Accordingly, in one embodiment, storage and processing circuitry associated with the electronic device embodying the display is configured to send a message to activate less than all of the total number of pixels.

Furthermore, the step of activating less than all of the total number of pixels of the display, as used herein, is intended to exclude situations wherein a specific aspect ratio image (e.g., video or photograph) is displayed on a different aspect ratio display. To be clear, the step of activating less than all of the total number of pixels excludes situations common when 4:3 image is displayed on a 16:9 display—where black boxes are on the right and left of the displayed image. In this situation, the failure to activate (if this even exists) is designed to fit the image to the display, as opposed to reduce power consumption of the display.

In an optional step 140, all of the total number of pixels of the display might be activated at some time after step 130. In fact, in certain embodiments, many of which were discussed above, the disclosed method for image display might revert back and forth between steps 130 and 140 (e.g., depending on the battery level or the type of image being displayed). Moreover, the back and forth nature of steps 130 and 140 might occur many times over, even for a given battery charge cycle. Additionally, step 140, in certain embodiments, may occur before step 130. The method for image display would conclude in an end step 150.

FIGS. 2A and 2B illustrate aspects of a representative embodiment of an electronic device 200 in accordance with embodiments of the disclosure. The electronic device 200 illustrated in FIG. 2 is depicted as a battery-operated electronic device. Examples of battery-operated electronic devices include smart phones, tablet computers, handheld computers, ultraportable computers, laptop computers, a combination of such devices, or any other suitable battery-operated electronic device including a display. Notwithstanding, other electronic devices are within the purview of this disclosure.

The electronic device 200 illustrated in FIGS. 2A and 2B includes a display 210. The display 210, in accordance with the disclosure, has a maximum display area (Aₘₐₓ) defined by a total number of pixels. In the embodiment of FIGS. 2A and 2B, the maximum display area (Aₘₐₓ) defined by a total number of pixels has a maximum width (Wₘₐₓ) and a maximum height (Hₘₐₓ). Accordingly, the display 210 illustrated in FIGS. 2A and 2B has a width to height aspect ratio of Wₘₐₓ:Hₘₐₓ. Depending on the type of electronic device 200, and model of the electronic device 200, the maximum display area (Aₘₐₓ), as well as the maximum width (Wₘₐₓ) and a maximum height (Hₘₐₓ), may vary greatly. Similarly, the aspect ratio Wₘₐₓ:Hₘₐₓ of the display 210 may vary.

The electronic device 200 illustrated in FIGS. 2A and 2B further includes storage and processing circuitry 220 associated with the display 210. The storage and processing circuitry 220, among other purposes, is operable to activate less than all of the total number of pixels of the display 210 and provide a modified display area (A_{mod}) that is less than the maximum display area (Aₘₐₓ). As discussed in detail above, the modified display area (A_{mod}) is operable to reduce power consumption of the display 210.

With brief reference to FIG. 2A, displayed on the electronic device 200 is an image 230a. In the illustrated embodiment, the image 230a displayed in FIG. 2A has a first image area (A₁). As the image 230a extends over substantially the entire display 210, the first image area (A₁) is substantially equal to the maximum display area (Aₘₐₓ). In fact, in this embodiment shown in FIG. 2A, all of the total number of pixels in the display 210 are being activated.

With brief reference to FIG. 2B, the electronic device 200 still displays the image, however, the image 230b displayed in FIG. 2B has a second lesser image area (A₂). In fact, the second lesser image area (A₂), in the embodiment shown, is substantially equal to the modified display area (A_{mod}), which is defined by a modified width (W_{mod}) and a modified height (H_{mod}). As discussed above, the storage and processing circuitry 220, in this embodiment, activated less than all of the total number of pixels of the display 210 to provide the image 230b having the second lesser image area (A₂).

In the embodiment of FIGS. 2A and 2B, an aspect ratio of the first image area (A₁) and an aspect ratio of the second image area (A₂) are substantially equal. Moreover, in the embodiment shown, bars of unactivated pixels exist along all four sides of the display 210 shown in FIG. 2B. In other embodiments, bars of unactivated pixels might exist along three sides of the display 210, or even along two sides of the display 210. In one embodiment wherein the bars of unactivated pixels exist along only two sides of the display 210, the two sides with unactivated pixels might be substantially perpendicular to one another.

Varying amounts of reduction in power consumption may be achieved by adjusting a size difference between the maximum display area (Aₘₐₓ) and the modified display area (A_{mod}). For instance, in one embodiment, the modified display (A_{mod}) area is at least about 20% less than the maximum display area (Aₘₐₓ), or even 33% less than the maximum display area (Aₘₐₓ). In another embodiment, the modified display (A_{mod}) area is at least about 50% less than the maximum display area (Aₘₐₓ). In yet another embodiment, the modified display (A_{mod}) area is at least about 66% less than the maximum display area (Aₘₐₓ), and in yet another embodiment the modified display (A_{mod}) area is at least about 75% less than the maximum display area (Aₘₐₓ). Similar reductions in power consumption might be achievable.

Turning to FIGS. 3A and 3B, illustrated is an alternative embodiment on an electronic device 300 manufactured in accordance with the present disclosure. The electronic device 300, in one embodiment, is similar to the electronic device 200 in many aspects. Accordingly, like reference numerals may be used to reference like features. The electronic device 300 of FIGS. 3A and 3B diverges from the electronic device 200 of FIGS. 2A and 2B with regard to the similarities, or dissimilarities, between the image displayed when the pixel activation reduction feature is employed.

With brief reference to FIG. 3A, displayed on the electronic device 300 is an image 330. In the illustrated embodiment, the image 330 displayed in FIG. 3A has a first image area (A₁). As the image 330 extends over the entire display 210, the first image area (A₁) is substantially equal to the maximum display area (Aₘₐₓ), which is defined by a maximum width (Wₘₐₓ) and a maximum height (Hₘₐₓ). In fact, in this embodiment shown in FIG. 3A, all of the total number of pixels in the display 210 are being activated.

In the embodiment of FIG. 3A, embedded within the image 300 is a particular sub-image 330a. In the embodiment shown, the sub-image 330a relates to a SMS Text Message that was received. In other embodiments, the sub-image 330a might relate to email information, caller information, etc. and remain within the purview of the present disclosure.

With brief reference to FIG. 3B, the electronic device 300, as opposed to displaying the image 330 (e.g., similar to the embodiment of FIGS. 2A and 2B), displays a portion of the image 330. In the embodiment shown, less than all of the total number of pixels of the display 210 are activated to only display the sub-image 330a (e.g., without the entire image 330). The image 330a displayed in FIG. 3B has a second lesser image area (A₂). In fact, the second lesser image area (A₂), in the embodiment shown, is substantially equal to the modified display area (A_{mod}), which is defined by a modified width (W_{mod}) and a modified height (H_{mod}). Accordingly, the storage and processing circuitry 220, in this embodiment, activated less than all of the total number of pixels of the display 210 to provide the image 330a having the second lesser image area (A₂).

In the embodiment of FIGS. 3A and 3B, an aspect ratio of the first image area (A₁) and an aspect ratio of the second image area (A₂) are not substantially equal, or in this embodiment even remotely similar. In the embodiment shown, bars of unactivated pixels exist along all four sides of the display 210 shown in FIG. 3B. Similar to the embodiment of FIGS. 2A and 2B, bars of unactivated pixels might only exist along three, or even only two, sides of the display 210.

FIG. 4 illustrates a schematic diagram of electronic device 400, as might be used with a display manufactured and operated in accordance with this disclosure. The aforementioned display, in accordance with the disclosure, would be operable to activating less than all of the total number of pixels of the display to provide a modified display area (A_{mod}) that is less than the maximum display area (Aₘₐₓ) to reduce power consumption of the display.

Electronic device 400 may be a portable device such as a mobile telephone, a mobile telephone with media player capabilities, a handheld computer, a remote control, a game player, a global positioning system (GPS) device, a laptop computer, a tablet computer, an ultraportable computer, a combination of such devices, or any other suitable portable electronic device. Electronic device 400 may additionally be a desktop computer, television, projector system, or any other battery-operated electronic device.

As shown in FIG. 4, electronic device 400 may include storage and processing circuitry 410. Storage and processing circuitry 410 may include one or more different types of storage such as hard disk drive storage, nonvolatile memory (e.g., flash memory or other electrically-programmable-read-only memory), volatile memory (e.g., static or dynamic random-access-memory), etc. The processing circuitry may be used to control the operation of device 400. The processing circuitry may be based on a processor such as a microprocessor and other suitable integrated circuits. With one suitable arrangement, the storage and processing circuitry 410 may be used to run software on device 400. The storage and processing circuitry 410 may, in another suitable arrangement, be used to run internet browsing applications, voice-over-internet-protocol (VOIP) telephone call applications, email applications, media playback applications, operating system functions, etc. Storage and processing circuitry 410 may be used in implementing suitable communications protocols.

Communications protocols that may be implemented using storage and processing circuitry 410 include, without limitation, internet protocols, wireless local area network protocols (e.g., IEEE 802.11 protocols—sometimes referred to as WiFi®), protocols for other short-range wireless communications links such as the Bluetooth® protocol, protocols for handling 3G communications services (e.g., using wide band code division multiple access techniques), 2G cellular telephone communications protocols, etc. The storage and processing circuitry 410 may implement protocols to communicate using cellular telephone bands at 850 MHz, 900 MHz, 1800 MHz, and 1900 MHz (e.g., the main Global System for Mobile Communications or GSM cellular telephone bands) and may implement protocols for handling 3G and 4G communications services.

The storage and processing circuitry 410 may additionally be configured to activating less than all of the total number of pixels of the display to provide a modified display area that is less than the maximum display area to reduce power consumption of the display, such is discussed in detail above.

Input-output device circuitry 420 may be used to allow data to be supplied to device 400 and to allow data to be provided from device 400 to external devices. Input-output devices 430 such as touch screens and other user input interfaces are examples of input-output circuitry 420. Input-output devices 430 may also include user input-output devices such as buttons, joysticks, click wheels, scrolling wheels, touch pads, key pads, keyboards, microphones, cameras, etc. A user can control the operation of device 400 by supplying commands through such user input devices. As discussed above, the user can control the operation of the device 400 using a display. Display and audio devices may be included in devices 430 such as liquid-crystal display (LCD) screens, light-emitting diodes (LEDs), organic light-emitting diodes (OLEDs), and other components that present visual information and status data. If desired, input-output devices 430 may contain audio-video interface equipment such as jacks and other connectors for external headphones and monitors.

Wireless communications circuitry 440 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications). Wireless communications circuitry 440 may include radio-frequency transceiver circuits for handling multiple radio-frequency communications bands. For example, circuitry 440 may include transceiver circuitry 442 that handles 2.4 GHz and 5 GHz bands for WiFi® (IEEE 802.11) communications and the 2.4 GHz Bluetooth® communications band. Circuitry 440 may also include cellular telephone transceiver circuitry 444 for handling wireless communications in cellular telephone bands such as the GSM bands at 850 MHz, 900 MHz, 1800 MHz, and 1900 MHz, as well as the UMTS and LTE bands (as examples). Wireless communications circuitry 440 can include circuitry for other short-range and long-range wireless links if desired. For example, wireless communications circuitry 440 may include global positioning system (GPS) receiver equipment, wireless circuitry for receiving radio and television signals, paging circuits, etc. In WiFi® and Bluetooth® links and other short-range wireless links, wireless signals are typically used to convey data over tens or hundreds of feet. In cellular telephone links and other long-range links, wireless signals are typically used to convey data over thousands of feet or miles.

Wireless communications circuitry 440 may include one or more antennas 446. Device 400 may be provided with any suitable number of antennas. There may be, for example, one antenna, two antennas, three antennas, or more than three antennas, in device 400. In accordance with that discussed above, the antennas may handle communications over multiple communications bands. If desired, a dual band antenna may be used to cover two bands (e.g., 2.4 GHz and 5 GHz). Different types of antennas may be used for different bands and combinations of bands. For example, it may be desirable to form an antenna for forming a local wireless link antenna, an antenna for handling cellular telephone communications bands, and a single band antenna for handling Bluetooth® communications (as examples).

Paths 450, such as transmission line paths, may be used to convey radio-frequency signals between transceivers 442 and 444, and antenna 446. Radio-frequency transceivers such as radio-frequency transceivers 442 and 444 may be implemented using one or more integrated circuits and associated components (e.g., power amplifiers, switching circuits, matching network components such as discrete inductors, capacitors, and resistors, and integrated circuit filter networks, etc.). These devices may be mounted on any suitable mounting structures. With one suitable arrangement, transceiver integrated circuits may be mounted on a printed circuit board. Paths 450 may be used to interconnect the transceiver integrated circuits and other components on the printed circuit board with antenna structures in device 400. Paths 450 may include any suitable conductive pathways over which radio-frequency signals may be conveyed including transmission line path structures such as coaxial cables, microstrip transmission lines, etc.

The device 400 of FIG. 4 further includes a chassis 460. The chassis 460 may be used for mounting/supporting electronic components such as a battery, printed circuit boards containing integrated circuits and other electrical devices, etc. For example, in one embodiment, the chassis 460 positions and supports the storage and processing circuitry 410, and the input-output circuitry 420, including the input-output devices 430 and the wireless communications circuitry 440 (e.g., including the WIFI and Bluetooth transceiver circuitry 442, the cellular telephone circuitry 444, and the antennas 446).

The chassis 460 may be made of various different materials, including metals such as aluminum. The chassis 460 may be machined or cast out of a single piece of material. Other methods, however, may additionally be used to form the chassis 460.

Those skilled in the art to which this application relates will appreciate that other and further additions, deletions, substitutions and modifications may be made to the described embodiments.

What is claimed is:

1. A method for image display, comprising:
providing a display, the display having a maximum display area (Aₘₐₓ) defined by a total number of pixels; and
activating less than all of the total number of pixels of the display to provide a modified display area (A_{mod}) that is less than the maximum display area (Aₘₐₓ) to reduce power consumption of the display.

2. The method as recited in claim 1, further including displaying an image having a first image (A₁) area substantially equal to the maximum display area (Aₘₐₓ), and further wherein activating less than all of the total number of pixels includes displaying the image having a second lesser image area (A₂) substantially equal to the modified display area (A_{mod}).

3. The method as recited in claim 2, wherein an aspect ratio of the first image area (A₁) is substantially equal to an aspect ratio of the second lesser image area (A₂).

4. The method as recited in claim 1, wherein activating less than all of the total number of pixels of the display causes bars of un-activated pixels to exist along three or more sides of the display.

5. The method as recited in claim 1, wherein activating less than all of the total number of pixels of the display causes bars of un-activated pixels to exist along all four sides of the display.

6. The method as recited in claim 1, further including separating proximately located pixels of the total number of pixels into equal number groups, and further wherein activating less than all of the total number of pixels of the display includes failing to activate one or more similarly placed pixels from each equal number group.

7. The method as recited in claim 1, wherein the activating is user definable.

8. The method as recited in claim 7, wherein the activating is based upon an amount of remaining battery life.

9. The method as recited in claim 1, wherein the modified display area (A_{mod}) is at least about 33% less than the maximum display area (Aₘₐₓ).

10. The method as recited in claim 1, wherein the modified display area (A_{mod}) is at least about 50% less than the maximum display area (Aₘₐₓ).

11. An electronic device, comprising:
a display having a maximum display area (Aₘₐₓ) defined by a total number of pixels; and
storage and processing circuitry associated with the display, the storage and processing circuitry operable to activate less than all of the total number of pixels of the display and provide a modified display area (A_{mod}) that is less than the maximum display area (Aₘₐₓ) to reduce power consumption of the display.

12. The electronic device as recited in claim 11, wherein the storage and processing circuitry is operable to display an image having a first image area (A₁) substantially equal to the maximum display area (Aₘₐₓ), and further wherein the storage and processing circuitry is operable to display the image having a second lesser image area (A₂) substantially equal to the modified display area (A_{mod}) by activating less than all of the total number of pixels.

13. The electronic device as recited in claim 12, wherein an aspect ratio of the first image area (A₁) is substantially equal to an aspect ratio of the second lesser image area (A₂).

14. The electronic device as recited in claim 11, wherein the storage and processing circuitry is operable to activate less than all of the total number of pixels of the display and cause bars of un-activated pixels to exist along three or more sides of the display.

15. The electronic device as recited in claim 11, wherein the storage and processing circuitry is operable to activate less than all of the total number of pixels of the display and cause bars of un-activated pixels to exist along all four sides of the display.

16. The electronic device as recited in claim 11, wherein the storage and processing circuitry is operable to separate proximately located pixels of the total number of pixels into equal number groups, and thereafter fail to activate one or more similarly placed pixels from each equal number group.

17. The electronic device as recited in claim 11, wherein the storage and processing circuitry is operable to activate less than all of the total number of pixels based upon an amount of remaining battery life.

18. The electronic device as recited in claim 11, wherein the modified display area (A_{mod}) is at least about 33% less than the maximum display area (Aₘₐₓ).

19. The electronic device as recited in claim 1, wherein the modified display area (A_{mod}) is at least about 50% less than the maximum display area (Aₘₐₓ).

20. The electronic device of claim 11, wherein the display and storage and processing circuitry form a portion of a battery-operated device selected from the group consisting of:
a laptop computer;
a tablet computer;
a handheld computer; and
a smart phone.
